(19) United States
(12) Patent Application Publication
(10) Pub. No.: US 2026/0219547 A1
(43) Pub. Date: Jul. 30, 2026

(54) Optical Device

(71) Applicant: NTT, INC., Tokyo (JP)

(72) Inventors: Hidetaka Nishi, Musashino-shi, Tokyo (JP); Shinji Matsuo, Musashino-shi, Tokyo (JP); Suguru Yamaoka, Musashino-shi, Tokyo (JP)

(21) Appl. No.: 19/149,161

(22) PCT Filed: Jan. 24, 2023
(86) PCT No.: PCT/JP2023/002050

§ 371 Date: Jul. 18, 2025

(51) Int. Cl. G02F 1/365

(52) U.S. Cl. CPC G02F 1/365

(57) ABSTRACT

This optical device includes a CSOI optical waveguide including an undercladding layer made of an insulating material with better heat dissipation properties than silicon oxide, and a core made of a compound semiconductor. The core is, for example, a so-called channel type having a rectangular cross-sectional shape. In addition, an overcladding layer is formed on the undercladding layer to cover the core. In addition, a bonding layer is provided between the undercladding layer and the core.

### TECHNICAL FIELD

The present invention relates to an optical device.

### BACKGROUND ART

In recent years, optical frequency Kerr comb technology that utilizes a third-order nonlinear effect in a micro-optical resonator has been progressing. In particular, compound semiconductor on insulator (CSOI) optical waveguides can utilize the high optical nonlinearity of compound semiconductors, and can also obtain strong optical confinement due to the large refractive index difference between compound semiconductors and SiO₂, making it possible to generate frequency comb light with high efficiency using extremely low pump light intensity.

In addition, by appropriately selecting the band gap of the compound semiconductor material, it is possible to suppress optical nonlinear absorption under high light intensity. So far, CSOI optical waveguides have been proposed that use AlGaAs, InP, InGaP, and GaP as group III-V compound semiconductors, SiC and SiGe as group IV compound semiconductor materials, and GaN and AlN as group II-IV materials. In particular, a CSOI optical waveguide using AlGaAs has been developed to realize a ring optical resonator with a high Q value exceeding 106, and it has been reported that a frequency comb light with an FSR of 1 THz can be generated at an extremely low threshold power of 36 μW using this high Q value ring optical resonator (Non Patent Literature 1).

Among the frequency comb lights, the frequency comb light realized in Non Patent Literature 1 is a light intensity generated periodically in the frequency (wavelength) domain, and coherence between the individual comb lights is not maintained. On the other hand, a comb in which coherence between the comb lights is maintained is referred to as a soliton comb. This is realized by creating a state in which soliton pulse light circulates within an optical resonator. Realizing a soliton comb state is important for applications such as spectroscopy and frequency reference, which require phase information of each comb line.

In recent years, it has been shown that this soliton comb state can be realized by continuously sweeping the pump light wavelength from the short wavelength side (negative pump light wavelength detuning) to the long wavelength side (positive wavelength detuning) with respect to the resonant wavelength of the optical resonator (Non Patent Literature 2).

In FIG. 7, a solid line (a) shows a relationship between the pump light wavelength detuning and the generated comb light intensity when a soliton comb state is generated. As the wavelength is swept from the negative wavelength detuning state to the long wavelength side, and the wavelength begins to enter the cavity and the light intensity exceeds the threshold, wavelength conversion occurs due to four-wave mixing (FWM), which is a third-order nonlinear optical effect, and comb light begins to be generated.

Due to the Kerr effect, which is also a third-order nonlinear optical effect, the resonant wavelength of the optical resonator also shifts toward longer wavelengths depending on the input light intensity (in the case of general nonlinear materials), so in order to obtain an effective zero detuning state, the wavelength is swept even further toward longer wavelengths. As the detuning approaches zero, the light intensity inside the optical resonator becomes stronger, and the power of the FWM wavelength conversion light also increases. As FWM occurs in a cascaded manner, a plurality of comb lines are generated, and the overall comb light intensity increases.

On the other hand, when the wavelength detuning exceeds the resonant wavelength, the comb light intensity drops sharply and then becomes constant with respect to the wavelength detuning (soliton step), as shown in region (b). This state is the soliton comb state, and it is known that it can be obtained by appropriately setting the wavelength sweep speed, etc. [Non Patent Literature 2]. As the wavelength sweep is continued, the optical power supplied to the optical resonator decreases and the soliton pulse can no longer be maintained at the detuning point, at which point the soliton comb state disappears and the comb light intensity becomes zero.

The solid line (a) is drawn taking into consideration the Kerr effect, but in reality there is also a resonant wavelength shift due to thermal effects (thermo-optical effect, thermal resistance, heat dissipation rate, etc.). It is known that the presence of thermal effects makes it even more difficult to generate soliton comb states, as described in Non Patent Literature 2. That is, when the wavelength sweep is continued and the effective zero detuning state is exceeded, the light intensity in the optical resonator decreases, so that the optical resonator temperature also decreases, and the resonant wavelength blue-shifts due to the thermo-optical effect. As a result, the actual comb light intensity reaches a soliton step through a process as shown by a broken line (c) in FIG. 7. In other words, on the low wavelength side of the pump light wavelength detuning that forms the soliton step, an inaccessible soliton comb state shown in region (d) exists.

Therefore, in order to realize a soliton comb state, it is important to obtain as large an accessible soliton step as possible, as shown in region (e), and it is important to make the inclination (−K_{eff}) of the broken line (c) as small as possible, that is, to make K_{eff} as large as possible. As described in Non Patent Literature 2, K_{eff} is expressed by the following formula.

$$\begin{matrix}[ Math . 1 ] & \\ {K}_{eff} = \frac{{n}_{g} {K}_{c}}{2 \frac{{κ}_{a} \partial n}{κ \partial T} {ω}_{p} {t}_{R}} & ( 1 )\end{matrix}$$

In Formula (1), n_{g} is the group refractive index, K_{c} is the thermal conductance of the optical resonator system (W/K), κₐ is the linear absorption loss rate inside the optical resonator (rad/s), κ is the loss rate of the entire optical resonator (rad/s), ∂n/∂T is the effective thermo-optic coefficient of the optical waveguide that constitutes the optical resonator (1/K), ωₚ is the angular momentum frequency of the pump light (rad/s), and t_{R} is the “round-trip time” (s) of the optical resonator. From Formula (1), in order to increase K_{eff}, guidelines such as increasing K_{c}, decreasing κₐ/κ, decreasing ∂n/∂, which shows the relationship between a refractive index n and a temperature T, and decreasing t_{R} are obtained.

### CITATION LIST

### Non Patent Literature

Non Patent Literature 1: L. Chang et al., “Ultra-efficient frequency comb generation in AlGaAs-on-insulator microresonators”, Nature Communications, vol. 11, no. 1, Article number: 1331, 2020.
Non Patent Literature 2: Q. LI et al., “Stably accessing octave-spanning microresonator frequency combs in the soliton regime”, Optica, vol. 4, no. 2, pp. 193-203, 2017.
Non Patent Literature 3: Gregory Moille et al., “Dissipative Kerr Solitons in a III-V Microresonator”, Laser & Photonics Reviews, vol. 14, issue 8, 2000022, 2020.

### SUMMARY OF INVENTION

### Technical Problem

There have been many reports on the generation of soliton combs, and compared to the SiN optical waveguide used in Non Patent Literature 2, the ∂n/∂T of a CSOI optical waveguide is about two orders of magnitude larger, resulting in a smaller K_{eff}. As a result, the broken line in FIG. 7 does not intersect with the soliton step, and there is a problem that generation of a soliton comb is extremely difficult.

To solve this problem, in Non Patent Literature 3, an optical resonator fabricated using an AlGaAs optical waveguide is cooled to an environment of 20 K or less in a refrigerator and pump light is injected into it, thereby reducing an/AT by about two orders of magnitude compared to room temperature to realize soliton comb generation. However, equipment such as a refrigerator to obtain a cryogenic environment of 20 K or less is required, which is a major problem.

Optical resonators using CSOI optical waveguides are expected to generate soliton combs with pump light intensities of submilliwatts. It is also expected that a semiconductor laser light source integrated on the same chip will be used as the pump light source to realize and put into practical use a single-chip soliton comb light source; however, laser driving is also difficult in an extremely cryogenic environment. Even in these future developments, technology that can generate soliton combs at room temperature, rather than operating in cryogenic environments, is required.

The present invention has been made to solve the above problems, and an object of the present invention is to make it possible to generate a soliton comb in a room temperature environment in an optical resonator using a CSOI optical waveguide.

### Solution to Problem

An optical device according to the present invention includes an optical waveguide including a cladding layer made of an insulating material with better heat dissipation properties than silicon oxide, and a core made of a compound semiconductor.

An optical device according to the present invention includes an optical waveguide including a cladding layer made of a material with a negative ∂n/∂T, which indicates a relationship between a refractive index n and a temperature T, and a core made of a compound semiconductor.

An optical device according to the present invention includes an optical waveguide including a cladding layer and a core formed on the cladding layer, in which the core includes a first core made of a compound semiconductor and a second core made of a material having a nonlinear optical effect in which ∂n/∂T, which indicates a relationship between a refractive index n and a temperature T, is lower than that of the compound semiconductor.

### Advantageous Effects of Invention

As described above, according to the present invention, it is possible to realize soliton comb generation in a room temperature environment in an optical resonator using a CSOI optical waveguide.

### BRIEF DESCRIPTION OF DRAWINGS

FIG. 1 is a cross-sectional view illustrating a configuration of an optical device according to a first embodiment of the present invention.

FIG. 2A is a characteristics diagram showing a result of calculating Lugiato-Lefever equation, which is generally used in soliton comb generation simulations, using a split-step Fourier method.

FIG. 2B is a characteristics diagram showing a spectrum of a region indicated by a double arrow in FIG. 2A and a pulse waveform in an optical resonator.

FIG. 3 is a characteristics diagram showing a relationship between an accessible range on a soliton step and K_{c} and κₐ/κ when taking into account thermal effects in a relationship between a comb light intensity and pump light wavelength detuning shown by the solid line (a) in FIG. 2A.

FIG. 4 is a cross-sectional view illustrating a configuration of another optical device according to the first embodiment of the present invention.

FIG. 5 is a cross-sectional view illustrating a configuration of an optical device according to a second embodiment of the present invention.

FIG. 6 is a cross-sectional view illustrating a configuration of an optical device according to a third embodiment of the present invention.

FIG. 7 is an explanatory diagram for describing generation of a soliton comb state.

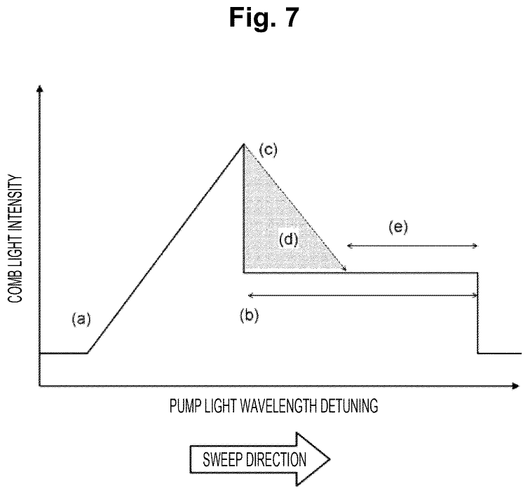

### DESCRIPTION OF EMBODIMENTS

An optical device according to an embodiment of the present invention will be described below.

### First Embodiment

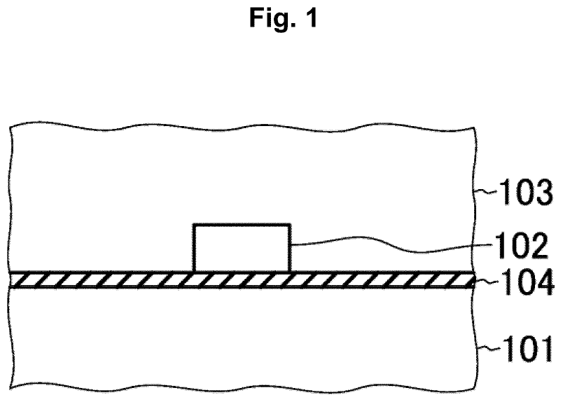

First, an optical device according to a first embodiment of the present invention will be described with reference to FIG. 1. This optical device includes a CSOI optical waveguide including an undercladding layer 101 made of an insulating material with better heat dissipation properties than silicon oxide, and a core 102 made of a compound semiconductor. This optical device is an optical resonator that includes a CSOI optical waveguide.

In this example, the core 102 is, for example, a so-called channel type having a rectangular cross-sectional shape, a height of 400 nm, and a width of 860 nm. In this example, an overcladding layer 103 is formed on the undercladding layer 101 to cover the core 102. Furthermore, in this example, a bonding layer 104 is formed between the undercladding layer 101 and the core 102 (overcladding layer 103). The bonding layer 104 may, for example, be 5 nm thick. In this example, the bonding layer 104 is formed to cover the entire surface of the undercladding layer 101.

The core 102 is made of AlGaAs (Al composition: 20%), and the undercladding layer 101 can be made of SiC, which is a material with high thermal conductivity. Moreover, the overcladding layer 103 can be made of SiO₂, and the bonding layer 104 can be made of SiO₂. By forming the undercladding layer 101 from SiC, it is possible to increase K_{c} in the above-mentioned Formula (1). As described above, in order to realize the soliton comb state, it is important to make K_{eff} as large as possible, and according to Formula (1), K_{eff} can be increased by increasing K_{c}. In the first embodiment, the cladding layer is made of a material with high thermal conductivity, thereby increasing K_{c} and increasing K_{eff} to realize soliton comb generation in a room temperature environment.

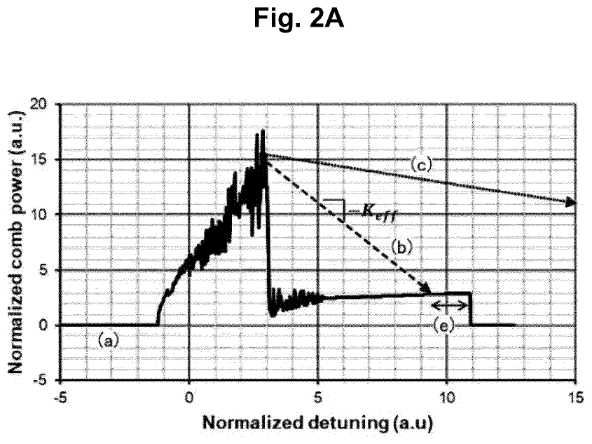

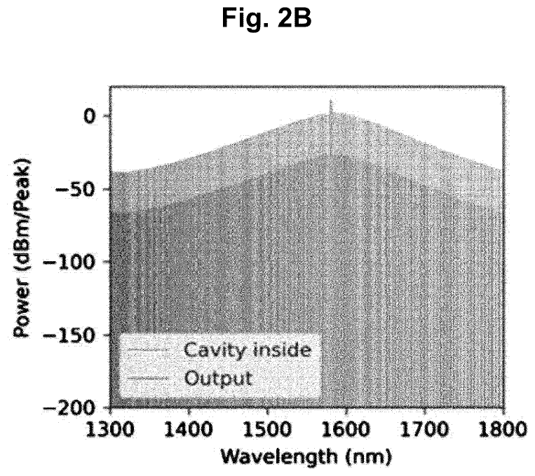

FIG. 2A illustrates a result of calculating Lugiato-Lefever equation (LLE), which is generally used in soliton comb generation simulations, using a split-step Fourier method. In FIG. 2A, the relationship between the comb light intensity and the pump light wavelength detuning is shown by a solid line (a). The pump light wavelength detuning is normalized to the half width of the optical resonator, and the comb light intensity is normalized to the input pump light to the optical resonator. A clear soliton step is present in a region indicated by a double arrow in FIG. 2A. When the spectrum of this region and the pulse waveform in the optical resonator are checked, it is a step in a single soliton state (FIG. 2B).

In this simulation, the parameters of the optical resonator were set as follows: ring radius 30 μm, internal Q value 0.49×106, pump light wavelength 1582 nm, and input light power 12 mW. A broken line (b) shows the transition of the comb light intensity taking into account thermal effects, which is calculated using K_{c} obtained from the material structure of each layer of the optical device (CSOI optical waveguide) described above. K_{c} was set to 1.0×10⁻³ (W/K), ∂n/∂T was set to 2.2×10⁻⁴ (1/K), which is the thermo-optic coefficient of AlGaAs at room temperature, and κₐ/κ was set to 0.15. Furthermore, an alternate long and short dash line (c) shows the transition of the comb light intensity taking into account the thermal effect in a structure equivalent to the optical waveguide of Non Patent Literature 3 in which the undercladding layer is made of SiO₂. K_{c} was set to 2.0×10⁻⁴ (W/K).

As shown in FIG. 2A, the broken line (b) has an intersection with the soliton step of the solid line (a), indicating that the soliton state is accessible. On the other hand, the alternate long and short dash line (c) does not intersect with the soliton step of the solid line (a), indicating that the soliton state cannot be accessed. That is, by using the structure of the optical device according to the above-mentioned first embodiment (see FIG. 1), it is possible to obtain an excellent effect that a soliton comb can be generated in the optical device according to the first embodiment at room temperature.

Next, a method for fabricating the optical device according to the first embodiment will be described. First, a Sic substrate is prepared, and a compound semiconductor epitaxial growth substrate having a layer structure of AlGaAs layer/sacrificial layer/GaAs substrate is fabricated using a crystal growth apparatus such as a general MOCVD apparatus.

Next, a bonding layer 104 made of SiO₂ is formed on the surface of the AlGaAs layer of the compound semiconductor epitaxial growth substrate by a general plasma CVD method or a sputtering method. Next, the surface of the bonding layer 104 of the compound semiconductor epitaxial growth substrate and the surface of the SiC substrate are bonded by a general surface hydrophilization bonding technique. Here, by providing a bonding layer 104 made of SiO₂ on the surface of the AlGaAs layer, bonding becomes easier, and excellent effects such as improved yield and suppression of voids can be obtained.

From the viewpoint of thermal conductivity, it is preferable not to provide the bonding layer 104. When the bonding layer 104 is not used, the top AlGaAs layer of the growth substrate and the SiC substrate can be bonded (joined) by a surface activation bonding technique using Ar plasma irradiation, for example, other than surface hydrophilization bonding.

Next, the GaAs substrate and the sacrificial layer on the compound semiconductor epitaxial growth substrate side are removed by wet etching.

Next, a hard mask layer made of SiO₂ is formed by a general plasma CVD method or a sputtering method. Next, a resist pattern for the optical waveguide and the ring optical resonator is formed on the hard mask layer by electron beam lithography or ultraviolet photolithography. Next, the hard mask layer is patterned by a dry etching technique using the resist pattern as a mask to form a hard mask pattern.

Next, the AlGaAs layer is patterned by a dry etching technique using the formed hard mask pattern, thereby forming a core 102 made of AlGaAs on the SiC substrate that will become the undercladding layer 101. Finally, when an overcladding layer 103 is deposited by a general plasma CVD method, the optical device structure described with reference to FIG. 1 is fabricated.

Assuming that a sufficiently large K_{eff} can be obtained to reach the soliton comb state, the undercladding layer 101 can be made of highly versatile SiO₂ (for example, instead of a SiC substrate, a Si substrate with a thermally oxidized surface can be used), and the overcladding layer 103 can be made of an insulating material (material with high thermal conductivity) that has better heat dissipation properties than silicon oxide such as SiC. Also, both the undercladding layer 101 and the overcladding layer 103 can be made of materials with high thermal conductivity.

By forming the core 102 from AlGaAs among group III-V compound semiconductors, the largest refractive index difference can be obtained with respect to the undercladding layer 101 made of SiC. The core can be made of InP, InGaP, or GaP, which have a lower refractive index than AlGaAs. A core made of these materials can achieve a similarly large refractive index difference to an undercladding made of SiC. However, when using these materials, the band gap of the compound semiconductor constituting the core is set so that nonlinear absorption can be sufficiently suppressed for the pump light wavelength.

It is generally known that in order to generate a soliton comb state, it is necessary to appropriately design the core size and control the structural dispersion to produce anomalous dispersion near the pump light wavelength. The core size in the above-described embodiment is merely an example, and can be appropriately adjusted based on the design concept of the present invention. Furthermore, the core shape is not limited to the so-called channel type, and can be a so-called rib type.

Although SiC (thermal conductivity 490 W/m/K) has been mentioned above as an example of the high thermal conductivity material constituting the cladding layer, the present invention is not limited thereto and diamond (thermal conductivity 2000 W/m/K) and the like can also be used. By using diamond, it is expected that an even larger K_{eff} can be obtained. In addition to these, various other materials can be applied with the intention of improving the thermal conductivity and increasing K_{eff} according to the present invention.

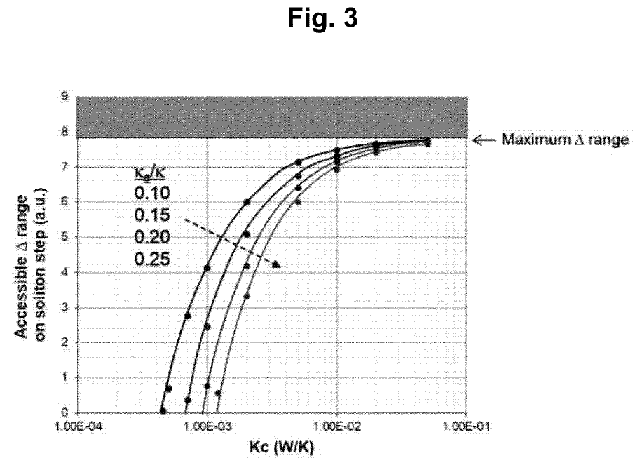

FIG. 3 shows a relationship between an accessible D range on a soliton step and K_{c} and κₐ/κ when taking into account thermal effects in a relationship between a comb light intensity and pump light wavelength detuning shown by the solid line (a) in FIG. 2A. It can be seen that as K_{c} increases, the accessible range on the soliton step also increases, making it easier to generate a soliton state. It can be also seen that the smaller κₐ/κ is, that is, the smaller the absorption loss rate at the internal Q value, the larger the accessible range on the soliton step also becomes, making it easier to generate a soliton state.

Furthermore, in the region where K_{c} is small (approximately 10⁻³ W/K), the change in the accessible range on the soliton step with respect to the change in κₐ/κ is large, whereas in the region where K_{c} is large (approximately 10⁻¹ W/K), the change in the accessible range on the soliton step with respect to the change in κₐ/κ is small. That is, if an optical device (optical resonator) having a sufficiently large K_{c} as shown in the first embodiment is realized, the accessible range on the soliton step is less susceptible to the magnitude of the absorption loss inside the optical resonator. It is generally known that the absorption loss inside an optical resonator strongly depends on the fabrication process, has a small degree of freedom in control, and is difficult to suppress. It is suggested that by using the structure of the optical device according to the present invention, a soliton comb light source that is robust against such phenomena that are difficult to control in the manufacturing process can be realized.

In FIGS. 2A and 3, calculations are performed for a soliton step that generates a single soliton state. However, it is well known that it is also possible to generate a multi-soliton state for a given optical resonator characteristic by changing the wavelength sweep conditions, etc. In this case, as described in Non Patent Literature 2, since the comb light power level of the soliton step increases, even if a single soliton state is inaccessible even with the same K_{eff}, a multi-soliton state may be accessible.

Naturally, the relationship between FIG. 2A and FIG. 3 changes depending on the characteristics of the optical resonator, the input light intensity, and the wavelength sweep parameters. In other words, by performing the analyses shown in FIGS. 2A and 3 based on the concept of the present invention in accordance with the target optical resonator, pump light driving parameters, and desired soliton state, it is possible to design a device with a thermally accessible soliton step.

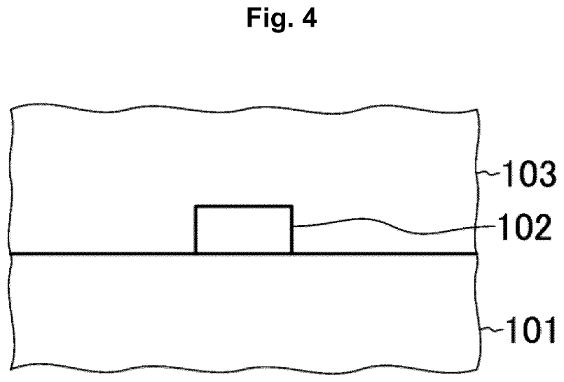

As illustrated in FIG. 4, a core 102 may be disposed on and in contact with an undercladding layer 101, and an overcladding layer 103 may be formed thereon. As described above, by eliminating the bonding layer with low thermal conductivity, it is possible to maximize K_{c}.

### Second Embodiment

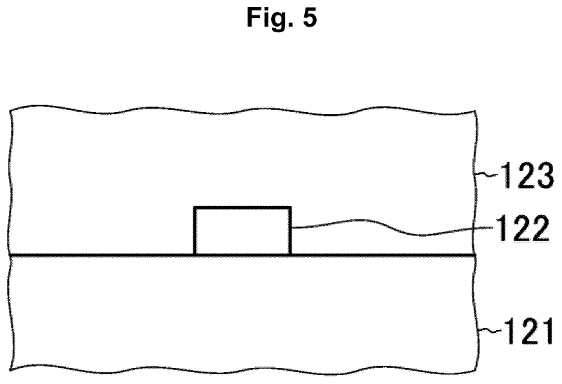

Next, an optical device according to a second embodiment of the present invention will be described with reference to FIG. 5. This optical device includes a CSOI optical waveguide including an undercladding layer 121, a core 122 made of a compound semiconductor, and an overcladding layer 123 formed on the undercladding layer 121 to cover the core 122. This optical device is an optical resonator that includes a CSOI optical waveguide. In the second embodiment, the overcladding layer 123 is made of a material with a negative ∂n/∂T, which indicates a relationship between a refractive index n and a temperature T. In the second embodiment, the undercladding layer 121 is made of SiC, which is a material with high thermal conductivity. The core 122 is formed on and in contact with the undercladding layer 121.

By forming the cladding layer (overcladding layer 123) from a material with a negative ∂n/∂T, it is possible to reduce ∂n/∂T in the above-mentioned Formula (1). As described above, in order to realize the soliton comb state, it is important to make K_{eff} as large as possible, and K_{eff} can be increased by making ∂n/∂T in Formula (1) smaller. In the second embodiment, the cladding layer is made of a material with a negative ∂n/∂T, thereby reducing ∂n/∂T in Formula (1) and increasing K_{eff} to realize soliton comb generation in a room temperature environment.

In this example, by forming the undercladding layer 121 from SiC, which is a material with high thermal conductivity, it is possible to increase K_{c} in the Formula (1), and further increase K_{eff}.

The material with negative ∂n/∂T can be, for example, titanium oxide or a polymer material having an electro-optical effect. Athermal optical filters using cladding layers made of these materials and Si, which has a large ∂n/∂T similar to compound semiconductors, as the core material have been realized, and similar configurations can be used. Furthermore, the material with negative ∂n/∂T shown here is merely an example, and depending on the material used, the core size can be designed appropriately while taking into consideration the realization of anomalous dispersion, the optical confinement factor, the comb generation threshold, etc.

### Third Embodiment

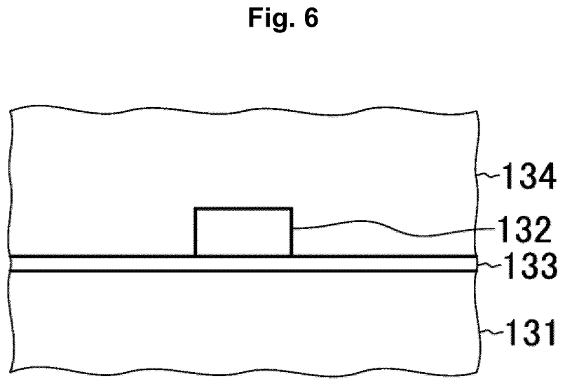

Next, an optical device according to a third embodiment of the present invention will be described with reference to FIG. 6. This optical device includes a CSOI optical waveguide including an undercladding layer 131, a first core 132 made of a compound semiconductor, a second core 133 formed on the undercladding layer 131, and an overcladding layer 134 formed on the undercladding layer 131 to cover the first core 132. This optical device is an optical resonator that includes a CSOI optical waveguide. The second core 133 is made of a material having a nonlinear optical effect, in which ∂n/∂T, which indicates the relationship between the refractive index n and the temperature T, is lower than that of the compound semiconductor that constitutes the first core 132. The second core 133 can be made of, for example, SiN.

In this example, a second core 133 formed in a slab shape is formed on and in contact with an undercladding layer 131, and a first core 132 is formed on and in contact with the second core 133. The second core 133 and the first core 132 form a rib shape as a whole. The second core 133 is not limited to a slab shape, but may be a channel shape. The undercladding layer 131 can be made of SiC, which is a material with high thermal conductivity. Additionally, the overcladding layer 134 can be made of SiO₂.

According to the third embodiment, by providing a first core 132 made of a compound semiconductor and a second core 133 made of a material having a nonlinear optical effect in which ∂n/∂T is lower than that of a compound semiconductor, it is possible to reduce ∂n/∂T in the above-mentioned Formula (1). As described above, in order to realize the soliton comb state, it is important to make K_{eff} as large as possible, and K_{eff} can be increased by making ∂n/∂T in Formula (1) smaller. In the third embodiment, a composite structure combining the first core 132 and the second core 133 reduces ∂n/∂T in Formula (1) and increases K_{eff}, thereby realizing soliton comb generation in a room temperature environment.

In this example, by forming the undercladding layer 131 from SiC, which is a material with high thermal conductivity, it is possible to increase K_{c} in the Formula (1), and further increase K_{eff}. Also in the third embodiment, similarly to the second embodiment, the overcladding layer 134 can be made of a material with a negative ∂n/∂T, which indicates the relationship between the refractive index n and the temperature T.

The above-mentioned materials are merely examples, and depending on the material used, the combination of the first core and the second core, the core size, and the like can be designed appropriately while taking into consideration the realization of anomalous dispersion, the optical confinement factor, the comb generation threshold, etc.

As described above, according to the present invention, since the cladding layer is made of an insulating material that has better heat dissipation properties than silicon oxide, a soliton comb can be generated in a room temperature environment in an optical resonator using a CSOI optical waveguide. In addition, according to the present invention, since the cladding layer is made of a material with a negative ∂n/∂T, which indicates the relationship between the refractive index n and the temperature T, a soliton comb can be generated in a room temperature environment in an optical resonator using a CSOI optical waveguide. Furthermore, according to the present invention, the core has a composite structure consisting of a first core made of a compound semiconductor and a second core made of a material having a nonlinear optical effect in which ∂n/∂T, which indicates the relationship between the refractive index n and the temperature T, is lower than that of a compound semiconductor. Therefore, a soliton comb can be generated in a room temperature environment in an optical resonator using a CSOI optical waveguide.

According to the present invention, K_{eff} is increased by increasing K_{c} in Formula (1) and reducing ∂n/∂T in Formula (1), thereby achieving the excellent effect of obtaining a soliton step region that can be realized in a room temperature environment in an optical resonator using a CSOI optical waveguide. This makes it possible to generate soliton combs in a room temperature environment with the extremely low pump light intensity that is a feature of optical resonators using CSOI optical waveguides, and has the excellent effect of making it possible to realize a soliton comb light source on a single chip integrated with a semiconductor laser.

Note that the present invention is not limited to the embodiments described above, and it is obvious that many modifications and combinations can be made by a person having ordinary knowledge in the art within the technical idea of the present invention.

### REFERENCE SIGNS LIST

101 Undercladding layer
102 Core
103 Overcladding layer
104 Bonding layer
121 Undercladding layer
122 Core
123 Overcladding layer
131 Undercladding layer
132 First core
133 Second core
134 Overcladding layer

1. An optical device comprising an optical waveguide including a cladding layer made of an insulating material with better heat dissipation properties than silicon oxide, and a core made of a compound semiconductor.

2. The optical device according to claim 1, wherein the cladding layer is made of one of SiC and diamond.

3. An optical device comprising an optical waveguide including a cladding layer made of a material with a negative ∂n/∂T, which indicates a relationship between a refractive index n and a temperature T, and a core made of a compound semiconductor.

4. The optical device according to claim 3, wherein the cladding layer is made of one of titanium oxide and a polymer material having an electro-optical effect.

5. An optical device comprising an optical waveguide including a cladding layer and a core formed on the cladding layer,
wherein the core includes a first core made of a compound semiconductor and a second core made of a material having a nonlinear optical effect in which ∂n/∂T, which indicates a relationship between a refractive index n and a temperature T, is lower than that of the compound semiconductor.

6. The optical device according to claim 5, wherein the second core is made of SiN.
